(19) United States
(12) Patent Application Publication
(10) Pub. No.: US 2023/0294636 A1
(43) Pub. Date: Sep. 21, 2023

(54) TAIL GATE SENSOR

(71) Applicant: Evian Anko, Shelby Twp., MI (US)

(72) Inventors: Evian Anko, Shelby Twp., MI (US); Kevin Mokerji, Rochester Hills, MI (US)

(73) Assignee: Evian Anko, Shelby Twp., MI (US)

(21) Appl. No.: 18/120,592

(22) Filed: Mar. 13, 2023

Related U.S. Application Data
(60) Provisional application No. 63/320,420, filed on Mar. 16, 2022.

(51) Int. Cl. B60R 25/24; G01S 15/04; B60R 25/01; E05F 15/40

(52) U.S. Cl. CPC B60R 25/24; G01S 15/04; B60R 25/01; E05F 15/40; E05Y 2400/54; E05Y 2400/85; E05Y 2900/546

(57) ABSTRACT

A key fob communicates with a vehicle to remotely control the opening and closing of a tailgate or rear vehicular trunk lid. The fob incorporates a CPU which emits RF signals which is the same usage as today's technology. The ultrasonic sensors can communicate either via a transducer or a transceiver. If an object is detected within the orbit or path of the tailgate, an audible sound is emitted, and the tailgate doesn't open. The transducer and/or transceiver are in communication with a body control module ECU within the vehicle.

This application is a Completion Application of co-pending U.S. Provisional Patent Application Ser. No. 63/320,420, filed on Mar. 16, 2022, for “Tailgate Sensor” the disclosure of which is hereby incorporated by reference, including the drawings.

### BACKGROUND OF THE INVENTION

### 1. Field of the Invention

The present invention pertains to vehicular tail gates. More particularly, the present invention concerns remotely controlling movement of a vehicular tail gate. Even more particularly, the present invention concerns a key fob sensor which remotely prevents travel of a tail gate if an object is detected in the path of travel.

### 2. Prior Art

As is known to those skilled in the art to which the invention pertains many vehicles such as SUVs, vans, etc. have tail or lift gates or rear door panels or trunk lids which open and close to enable loading of a cargo bay area or the like. Many of these tail gates are either in-vehicle or remotely operated and can be actuated to open and close by the driver through a relay located in the passenger compartment.

In a typical tail gate equipped vehicle, ordinarily a key fob used to remotely open and close the tail gate. Ordinarily, a radio frequency (RF) is used as the activation signal. Typically, a key fob has two identifications (ID), namely, an intelligent key ID 2 and a Near Vertical Incidence Skywave (NVIS) ID A Body Control Module (BCM) inside the vehicle performs the ID verification between itself and the key fob when the key fob RF (radio frequency) is transmitted into the detection area of the normal vehicle rear end antenna to enable it to perform the tail gate operation. When the BCM receives the tail gate open request signal, it reads the input from an ultrasonic sensor. If an object is detected, then it operates the tailgate release solenoid by opening the tail gate. If the RFID signals match, and the sensor detects an object, the BCM will finish its command by sending a serial data message to the instrument cluster via a Controller Area Network (CAN) which will then either display the tail gate open warning or sound an audible alarm to inform the user that the tail gate did not open due to the object detection.

As is also known, tail gates do not travel in a vertical pathway but, rather, in an orbital pathway. Thus, if an object, such as a person, travels or is situated within the orbital path, he or she may be injured if the operator does not see or detect the presence of such person within that orbital path when the tail gate is being opened or closed unless the vehicle meets ISO 26262 functional safety standards and there is no malfunction.

Further, it is to be appreciated that where a key fob is used to remotely actuate a tail gate, oftentimes it is impossible to detect the presence of a person or object within the path of travel since the vehicle is not in the view of the operator.

Thus, it is to be appreciated regardless if the vehicle meets the functional safety standard that a major advance would be provided by a remote key fob having a sensor which can detect the presence of an object within the orbital path of a tail gate to prevent it from being actuated to either open or close. It is to this to which the present invention is directed.

### BRIEF DESCRIPTION OF THE DRAWINGS

FIG. 1 is an illustration of a present key fob;

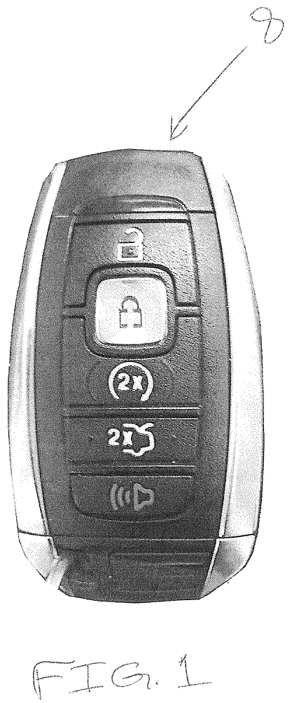

FIG. 2 is a side view of a vehicle depicting a tail gate orbital path;

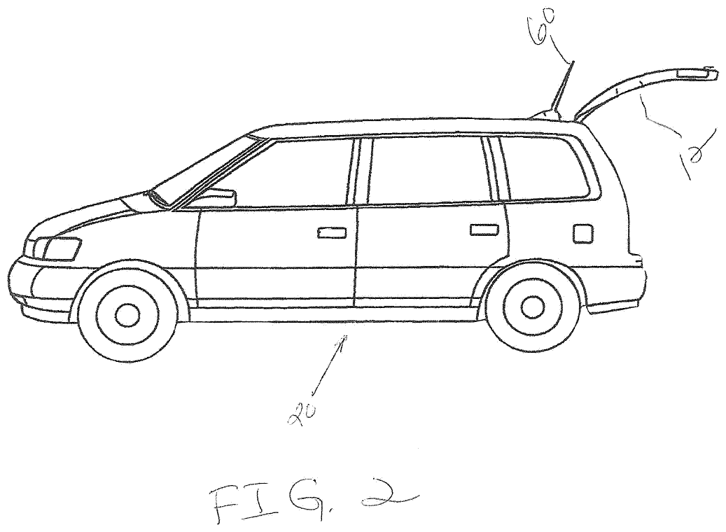

FIG. 3A is a flow chart depicting a data stream for the key fob using a transceiver hereof;

FIG. 3B is a flow chart depicting a data stream for the key fob using a transducer; and

FIG. 4 is a rear view of a vehicle showing the sensors installed thereon and the field of coverage.

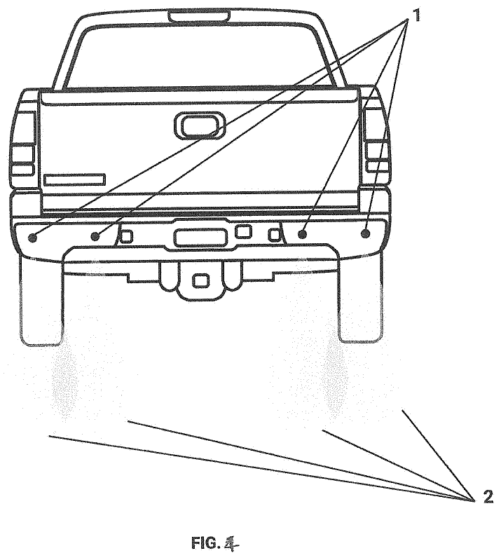

### SUMMARY OF THE INVENTION

The present invention provides an ordinary short-range RF transmitter key fob which comprises a circuit board having an integrated circuit or CPU for processing information and which can modulate and demodulate radio frequencies.

The fob sensor is in communication with the BCM which in turn communicates with the ultrasonic sensors, which are typically mounted in the rear bumper of a vehicle.

For a more complete understanding of the present invention, reference is made to the following detailed description and accompanying drawing. In the drawing, like reference characters refer to like parts throughout the several views in which:

### DESCRIPTION OF THE INVENTION

In accordance herewith and with reference to the drawing, there is provided a (remotely operated) key fob 8 which typically includes a signal emitter 10 for remotely operating the opening and closing of a vehicle tail gate 12.

The fob hereof, also, includes a sensor 14 which verifies the absence of an object in the vicinity of the trajectory or path of the tail gate 12 to prevent injury to such object.

The fob 8 (not shown) includes a circuit board having an integrated circuit or CPU for processing information, and which can modulate and demodulate radio frequency signals. Such boards are well known and commercially available.

The key fob 8, which is ordinarily push button operated, further includes a short-range RF transmitter for opening the vehicular tail gate 12.

As is known to those skilled in the art when the push button is depressed on the key fob, it actuates the CPU inside the fob which then sends a data stream to the RF transmitter.

In other words, a data stream is a pre-encoded signal (modulation signal) which is sent to the body control module (BCM) equipped with a radio frequency (RF) receiver as at 22. If the transmitted RF code matches that of the RF receiver, then it starts the action of attempting to open the tail gate. If there is no action, then there is no actuation and in lieu thereof, an alarm is sounded to notify the user of an object in the vicinity of the tail gate.

The present invention further includes means for actuating an audible alarm to notify the user that an object is in the path of the trajectory of the tail gate.

More particularly and as shown, the present invention is associated with a vehicle 20 having a tail gate 12 equipped with a smart entry system which can be actuated through the key fob 8.

Typically, these vehicles are equipped with a body control module (BCM), as well as an antenna 60 disposed proximate the rear of the vehicle. The body control module regulates the opening and closing of the tail gate 12.

Object detection per se is achieved through the climate of various ultrasonic sensors 30 that are mounted in the rear bumper of the vehicle 20 and which communicates with the fob sensor. The sensor used herein may comprise either (a) a transceiver using only I/O pin (TX/RX), or (b) a transducer which uses two I/O pins identified as TRIGGER(TX) and ECHO(RX), respectively. It should be noted, alternatively Radars or cameras working in conjunction with radars or lidars may be used as an object detection sensor.

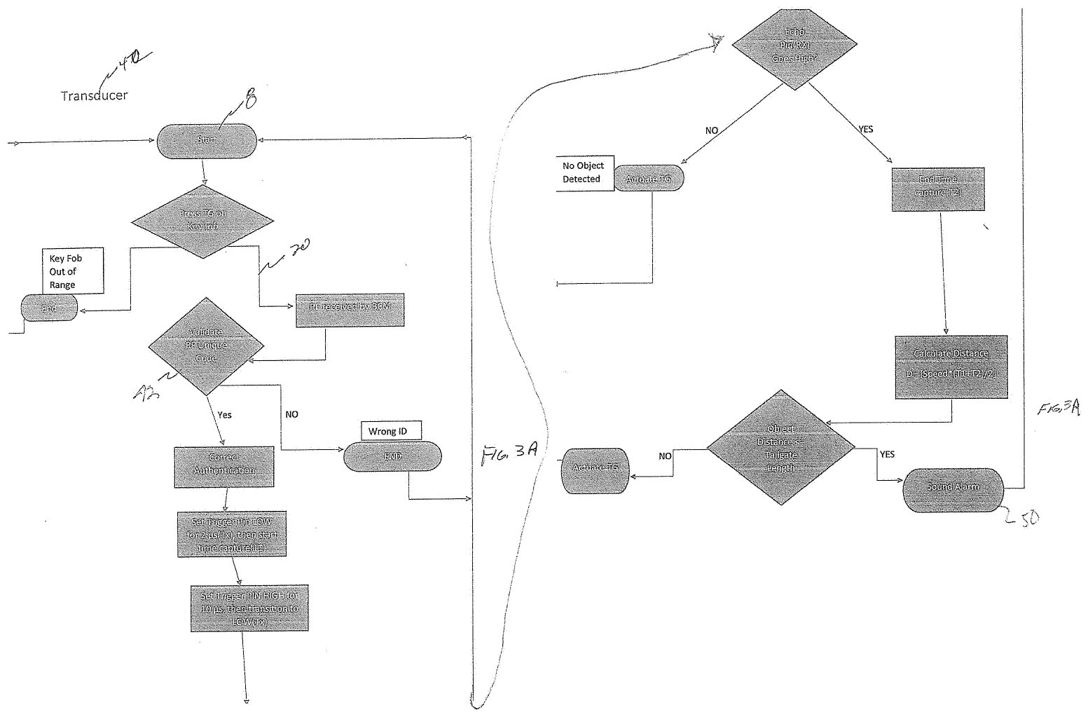

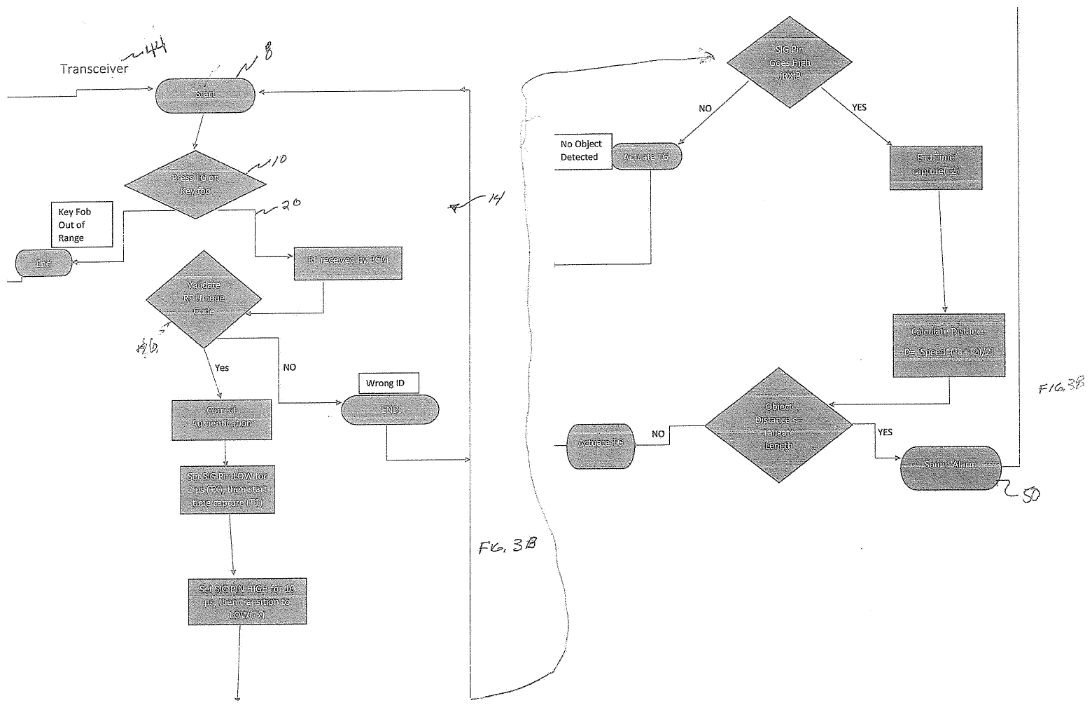

In use and according to the present invention, and as shown in the data flow of FIG. 3A and assuming the fob has transducer 40 incorporated thereinto, the key fob 8, only becomes actuable, when in a pre-set range to send a signal to the body control module which, in turn, validates the radio frequency (RF) signal sent by the fob as at 42. If there is no match, then nothing occurs. If there is a match, then a pre-set trigger or echo pin operates between a low point and high point. Similarly, and as shown if the key fob signal is out of range nothing happens.

With a transceiver 44, a burst of pulses is sent from the fob. If it bounces off the object then the echo is received on the same I/O line.

Regarding the I/O pin with one I/O Sig line, it is initiated by beginning a time capture (T1) while sending a burst of pulses. After the burst the time capture begins, followed by a latency. If an object is detected as at 46, the wave bounces off the object, which drives the same I/O Sig pin LOW-HIGH. A time capture (T2) ends at this sequence. Calculating the distance according to the formula of ((T1+T2) *Speed/2), (i.e., for ultrasonic the speed of sound is used, for a Lidar or Radar sensor the speed of light is used).

Alternatively, and as shown in FIG. 3B in utilizing a transducer 44 with two I/O lines, if a transducer is used one pin is used as the trigger pin (Tx) and the other pin is designated as the receiving echo line (RX) this first line sets the time capture (T1) as it utilizes one of its I/O pins to drive the trigger I/O pin LOW-HIGH by dispersing a multitude of pulses, followed by a latency, which, then, if it detects an object, then the echo pin (RX) data line is driven from LOW-HIGH. This is where time capture ends (T2). In either scenario the same distance formula is used to get the time of flight which is I.E. [(T1+T2)*Speed/2].

If the distance indicates that the object will encounter the tail gate, an alarm 50 is sounded to alert the operator to stop the tail gate from lifting. If not, then the tail gate is actuated to either open or close.

The sensors hereof also include ADA warning technology using ultrasonic sensors and which includes parking assist. Thus, when a user shifts the vehicle transmission into the reverse position and begins to back up, the sensors send out ultrasonic waves that bounce off an object when an object is detected in the rear trajectory of the vehicle. This information is reported to the body control module. The sensors and body control module work in parallel. Thus, when an object is detected within a given range, the body control module sends out a CAN object detected signal to the instrument cluster to sound the audible alarm whose alarm volume is contingent upon how close the object is when the vehicle moves in reverse. The closer the object is, the louder the alarm volume.

It should be noted that although the present invention has been described with reference to a tail gate, it is equally applicable to a vehicular trunk lid.

It is to be appreciated that the present invention is integrated into present day combined lane change assist and rear, cross-traffic alert functionality such as disclosed in U.S. patent Ser. No. 8,965,678 and U.S. Patent Publication No. US2012/0041632-A1, the disclosures of which are hereby incorporated by reference.

Having, thus described the invention, what is claimed is:

### REFERENCE NUMERALS

8 key fob
10 emitter
12 tail gate
14 sensor
20 vehicle
22 receiver, entry system
30 ultrasonic sensors
40 transducer
42 radio frequency signal
60 antenna
44 transceiver

1. A key fob for remotely controlling the opening and closing of a vehicular tailgate, comprising:
(a) a housing;
(b) a sensor disposed within the housing;
(c) a central processing unit for processing information;
(d) a radio frequency transmitter which emits and sends a signal to a vehicular body control module having a radio frequency receiver.

2. The fob of claim 1 which comprises a transducer for transmitting a signal sent by the RF transmitter.

3. The fob of claim 2 wherein the transducer is in a preset range for sending the signal to the body control module.

4. The fob of claim 2 wherein the transducer comprises two I/O pins.

5. The fob of claim 1 where the RF transmitter is a transceiver.

6. The fob of claim 4 where the transceiver comprises a single I/O pin.
